(19) United States
(12) Patent Application Publication
(10) Pub. No.: US 2010/0250366 A1
(43) Pub. Date: Sep. 30, 2010

(54) MERGE REAL-WORLD AND VIRTUAL MARKERS

(75) Inventors: Leonard Smith, Seattle, WA (US); Gur Kimchi, Redmond, WA (US); Stephen L. Lawler, Redmond, WA (US); Avi Bar-Zeev, Redmond, WA (US); Blaise H. Aguera y Arcas, Seattle, WA (US); Eyal Ofek, Redmond, WA (US); Kaveh Goudarzian, Seattle, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/415,778

(22) Filed: Mar. 31, 2009

(51) Int. Cl. G09G 5/00; G01C 21/00; G06Q 30/00

(52) U.S. Cl. 705/14.58; 345/629; 701/208

(57) ABSTRACT

Various entities might desire to leave markers at various locations in a mapping application for themselves and others. These markers can be provided by an entity physically located near the location associated with the marker and/or at a different location (e.g., entity is at a first location and the marker is associated with a second location). Further, different entities can provide markers associated with a similar geographic area. A user visiting the location (virtually or physically) can review the various markers left by others. In such a manner, the user visiting the location can have further details associated with the location. Different categories of markers can be combined and rendered to the user as a hybrid of markers.

### BACKGROUND

Since the development and commercial access to Global Positioning System (GPS) and other Global Navigation Satellite Systems (GNSS), as well as various other Location-Based Services (LBS), numerous computer applications have been built around understanding a user's location and leveraging that location knowledge, often in connection with a stated destination or near-by points of potential interest. For example, GPS navigation systems were first utilized in connection with two-dimensional orthographic projection maps to assist users to travel from location to location. GPS (or other LBS systems) have expanded to assist in discovering and delivering general information about a user's current location, and can include information about local business listings, advertisements, and so forth.

Given a user's location, conventional devices can provide directions to specific locations and, in some cases, can allow users to discover services or content relevant to a current location. Such services can even be helpful at a street-level scale. However, current systems and methods for understanding the location of a user do not provide the granularity to understand a real context of a user.

People utilize computing devices as a means to communicate and stay “connected” while moving from place to place and such communication can be instantaneous or in real time. Such information exchange can occur by entering text, visual, audio, or other forms of information into a display area and communicating with another user in a back-and-forth manner. This instantaneous communication allows users in disparate locations to communicate in a real time fashion with or without using another means of communication (e.g., telephone). Technology of such mobile computing devices has advanced to the point where data regarding any desired content is readily available. For example, many people utilize mapping technologies to view areas of interest, such as a hometown or a vacation spot, to obtain driving directions, or for a variety of reasons.

### SUMMARY

The following presents a simplified summary in order to provide a basic understanding of some aspects of the disclosed examples. This summary is not an extensive overview and is intended to neither identify key or critical elements nor delineate the scope of such aspects. Its purpose is to present some concepts in a simplified form as a prelude to the more detailed description that is presented later.

In accordance with one or more examples and corresponding disclosure thereof, various aspects are described in connection with dynamically merging real-world markers (e.g., markers left by a user physically at (or near) a location), virtual markers (e.g., markers left by a user virtually visiting a location), and/or “potential location” markers (e.g., markers that belong to a first location although the markers appear to belong to a second location) to create a hybrid of markers. In such a manner, people can be provided with an extra level of information that combines experiences, views, and other information provided by people that have physically been at a place and those people that virtually visited the location. The merging of the markers can be based on a group of trusted individuals (e.g., family members, friends, associates) or can be based on a group of unrelated individuals. A user reviewing the markers can make an informed decision based on the merged markers. Further, the user can take into account the type of marker (real world, virtual, and so forth) and make a determination as to the trustworthiness of the data.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the various aspects may be employed. Other advantages and novel features will become apparent from the following detailed description when considered in conjunction with the drawings and the disclosed examples are intended to include all such aspects and their equivalents.

### BRIEF DESCRIPTION OF THE DRAWINGS

FIG. 1 illustrates a system that facilitates merging of different types of markers in a mapping application according to an aspect.

FIG. 2 illustrates a system for selectively rendering merged markers based on a request, in accordance with an aspect.

FIG. 3 illustrates a system for selecting one or more markers for output to a user in accordance with an aspect.

FIG. 4 illustrates a system for selectively merging two or more markers, according to an aspect.

FIG. 5 illustrates a system that employs machine learning and reasoning to automate one or more features in accordance with the disclosed aspects.

FIG. 6 illustrates a method for rendering markers in a mapping application, according to an aspect.

FIG. 7 illustrates a method for selecting one or more markers for output to a user in accordance with the disclosed aspects.

FIG. 8 illustrates a method for selectively merging two or more markers, according to an aspect.

FIG. 9 illustrates a block diagram of a computer operable to execute the disclosed architecture.

FIG. 10 illustrates a schematic block diagram of an exemplary computing environment in accordance with the various aspects.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Computing systems employing automated learning and reasoning procedures (e.g., the use of explicitly and/or implicitly trained statistical classifiers) can be employed in connection with performing inference and/or probabilistic determinations and/or statistical-based determinations as in accordance with one or more aspects as described hereinafter. As used herein, the term “inference” refers generally to the process of reasoning about or inferring states of the system, environment, and/or user from a set of observations as captured through events, sensors, and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

Additionally, in the subject description, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

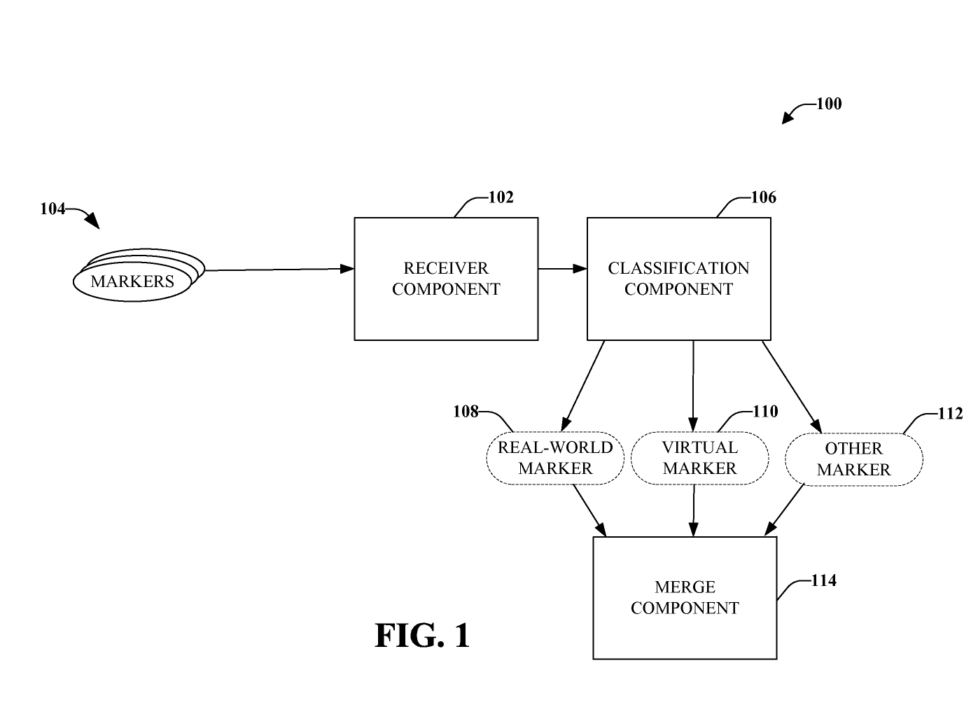

Referring initially to FIG. 1, illustrated is a system 100 that facilitates merging different types of markers in a mapping application according to an aspect. As utilized herein a “marker” refers to any information, data, advertisement, photograph, drawing, sensation, fragrance, hyper-link, an index to a database, comments, ratings, threaded conversations, traffic, news streams, global events, and so forth, and/or other content that can be perceived (e.g., visual, audible, tactile, and so forth). Markers can be personalized markers intended specifically for a user (e.g., a message from a friend) and/or generic markers (e.g., an advertisement intended for persons that are near the advertiser's business). In accordance with some aspects, markers can be associated with geographic coordinates, applied to a mapping application, driving directions, and/or other location based applications. According to some aspects, markers can be conditional such that the marker can be seen only from certain directions, zoom level, specific activity of the user that conforms to a profile of the marker. Markers can be associated with calendar events, according to some aspects. For example, a marker can be rendered based on temporal criteria. System 100 can be included, at least partially, in a user device (e.g., computer, phone, or other computing device), which can be wired and/or wireless. The user device can be carried by the user (e.g., hand, pocket, purse, and so on) or by a vehicle associated with the user (e.g., bicycle, automobile, motorcycle, boat, or through other manners of transportation).

System 100 is configured to allow users and/or entities to leave information (in the form of a marker) at certain locations as a prompt to themselves or to convey information to others. Thus, system 100 allows users to create markers and consume their own markers, other people's markers, and yp data. The user can be physically at the location and provide a real-world marker. For example, a user can be out of town on business and can notice a restaurant that looks interesting or has been recently recommended but was not visited. Therefore, the user can leave a real-world marker to remind herself to visit that restaurant on the next trip. Alternatively, the user can visit the restaurant and provide a recommendation for others (e.g., “This restaurant was excellent.”) in the form of a real-world marker.

In accordance with some aspect, there can also be users that are navigating a virtual mapping application (e.g., surfing the Internet) and visiting different sites virtually. These people might also leave markers for themselves or for others, which are referred to herein as virtual markers. These markers can be based on information the user would like to associate with the location. Alternatively or additionally, the marker can be based on prior personal experience or other factors (e.g., questions that a user would like answered) associated with the virtual location.

Alternatively or additionally, markers can be in the form of “potential locations.” For example, an individual is in a restaurant, however, an indoor location reading (e.g., GPS reading) implies that the current location is on the street in front of the restaurant. In another example, if the individual is in their office, the location reading might indicate that the individual is half a mile away due to receiving problems. These “potential location” can alternatively be referred to as quasi-real-world markers and/or quasi-virtual markers. Further, markers can be classified as child markers that relate to one or more parent markers.

Included in system 100 is an input component 102 that receives a multitude of markers 104 associated with a location in a mapping application. Any two or more of the markers can be received at about the same time or at different times (e.g., over a period of minutes, hours, days, weeks, months, and so forth). Further, the multiple markers can be provided by a number of different users and/or entities. As utilized herein, “entities” refers to people, commercial (as well as non-commercial) establishments, government bodies, and/or other types of commercial interactions and/or social interactions that can occur in the environment. Further, “entities” can refer to the Internet, another system, and so forth. The term “user” is used interchangeably with “entity”, “entities”, or the like.

In an example, a first person can physically visit a particular location while, at about the same time (or at a different time), another person is viewing a similar location in a mapping application. Both people can input markers and, in accordance with some aspects, the markers can be output to the other person at substantially the same time as the marker is received by system 100. However, in accordance with some aspects, there can be a delay in outputting the marker. For example, the marker can be examined (e.g., automatically or manually) for content, conformance with guidelines, policies and/or rules, reliability of the marker, as well as other factors (e.g., privacy considerations). Thus, until the marker has been examined, the marker might not output to other users. If the marker is found to be in conformance, the marker can be perceived by others. However, if the marker is not in conformance with established guidelines, the marker might only be viewable by the person that input the marker or, according to some aspects; the marker can be automatically deleted. In accordance with some aspects, a marker might not be inspected but still might be available to at least a subset of entities (e.g., the user that provided the marker, a list of friends associated with the user as determined from a listing of friends or a contact database) and so forth.

It should be noted that the location associated with a marker 104 does not have to be the same exact geographic coordinates, address, or other manner of identifying the location and/or with which the marker relates. Instead, a similar location can be determined by approximate location. For example, a determination can be made whether markers are related to a similar location (e.g., specific landmark). Although each user can be viewing the landmark from a different location and/or can be different distances away from the landmark, and so forth) the marker might be for the same location (e.g., building, landmark, or other object perceivable in a mapping application). In accordance with some aspects, the maker refers to more than just a point but, instead, additionally or alternatively refers to a road, street, area, volume, and so forth.

Also included in system 100 is a classification component 106 that is configured to index each of the multitudes of markers 106 as real world markers 108, a virtual markers 110, or another category of markers 112. Each marker can be indexed as a function of a user location and a location of the marker in the mapping application. If the user location and the marker location in the mapping application are approximately the same, the marker is classified as a real-world marker 108. However, if the marker location in the mapping location and the user location are different (e.g., the marker location is in New York and the user location is Florida), the marker is classified as a virtual marker 110. Further, if the user location and the marker location do not match exactly but are within range of each other (e.g., less than half a mile apart, less than one mile apart, less than three miles apart, and so forth), the marker can be classified as another type of marker 112 (e.g., potential location marker, quasi-real-world marker, quasi virtual marker, and so on). In accordance with some aspects, the user can simply point the user device to an object in the user's line of sight and mark that object. For example, the user might be able to view Mt. Rainer from Seattle, point to the mountain and mark it, which can be considered a real-world marker, a potential marker, a child marker, and so forth. In another example, the user can point to the moon and mark the moon, which can be classified as a child marker, a real-world marker, and so forth.

The classification component 106 can tag each marker with the appropriate classification or category. For example, metadata that identifies the category can be included in the marker. This marker type identifier can allow others, upon perceiving the marker, to know which type of marker it has been categorized as and a determination as to the value of each marker can be made by each individual.

A real-world marker can increase the reliability of a virtual marker (or other type of marker). This is beneficial since some markers can be false due to incorrect information, a malicious user, or based on other factors. In the case of real-world markers, a visit of a user to the same place in the real world can increase verification of other markers that might be considered less reliable.

A merge component 112 selectively merges two markers, which can be of a same classification and/or a different classification, or combinations thereof. Merging can include embedding markers together, wherein a dominant marker is output and, if desired, a user can drill down into the marker to view the embedded markers. Thus, if a user is only interested in the most relevant markers, the user does not have to view all the similar (embedded) markers. In accordance with some aspects, merging of markers includes deleting duplicate markers, deleting markers that are determined to be unreliable (e.g., based on a threshold of reliability), and/or deleting markers that are deemed undesirable (e.g., that contain questionable content, that violate privacy policies, and so forth).

Merging of the different marker types can be performed by merge component 114 when a request is received for information associated with a mapping location. For example, a user might be visiting a particular location (e.g., restaurant) and desires to receive reviews about the restaurant that have been provided by others. That user can request information (e.g., markers) for that restaurant and be provided real-world markers 108, virtual markers 110, and other markers 112. In accordance with some aspects, the merging of similar markers can occur at substantially the same time as receiving a similar marker, which can mitigate an amount of time between a request for a marker and output of the marker.

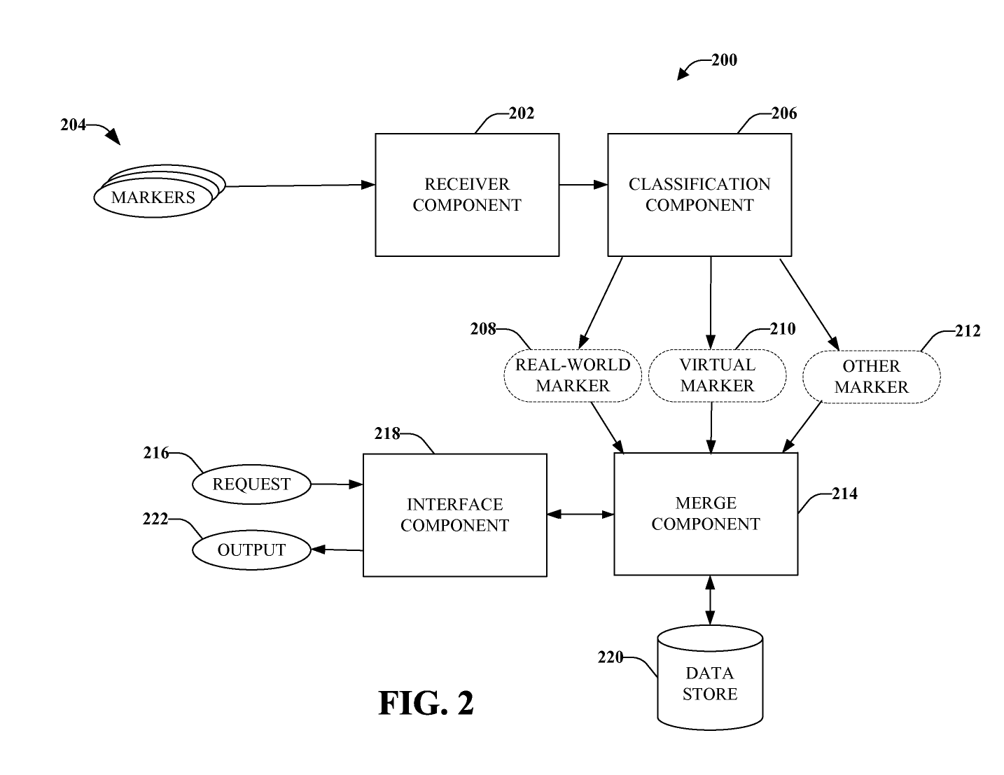

FIG. 2 illustrates a system 200 for selectively rendering merged markers based on a request, in accordance with an aspect. System 200 is configured to selectively render one or more merged markers as a function of parameters associated with an entity requesting the markers.

Included in system 200 is a receiver component 202 that accepts markers 204 from numerous sources. Each marker can be associated with substantially the same (or a different) geographic location, which can be accessed though a mapping application. A classification component 206 indexes each of the received markers 204. For example, the index can be based on whether that marker was input (by the source) at substantially the same geographic location to which the marker relates, and thus is a real-world marker 208. Another category of markers is a virtual marker 210, which is identified by the source of the marker having a first geographic location and the marker is related to a second geographic location.

Still a further category can relate to “potential locations”, which are locations that are near to where the provider of the marker is physically located, however, the device associated with that person indicates that the person is in a different location. For example, the user might be in a building; however, the user device indicates that the user is one block away on the street. A range can be established whereby if there is a question related to a location, the user can be provided a list (e.g., a short list) of likely locations. This list can be sorted according to different criteria (e.g. the most recent confirmed location, historical locations visited by the user, and so on). The user can select a location from the list. In accordance with some aspects, the user can enter a new location in order to improve the geocoding of the user device.

A merge component 214 can selectively combine one or more real-world markers 208, virtual markers 210, and/or other markers 212. In accordance with some aspects, real-world markers 208 are combined with other real-world markers 208, virtual markers 210 are combined with other virtual markers 210, markers 212 of another classification are combined with markers 212 of a similar (or a different) classification, or combinations thereof (e.g., one real-world marker 208 is combined with two or more virtual markers 210, one virtual marker 210 is combined with two or more real-world markers 208, one other type of marker 212 is combined with two or more virtual markers 210, one other type of marker 212 is combined with two or more real-world markers 208, or combinations thereof).

As an entity is navigating though physical space (e.g., is actually present at a geographic location) and/or virtual space (e.g., is visiting a location over the Internet), the user can request 216 markers associated with that geographic location. The request 216 can be facilitated through interaction with an interface component 218. In accordance with some aspects, receiver component 202 can be included in interface component 218. For example, a user can provide markers 204 through receiver component 202 and can request 216 markers through interface component 218. The requested markers can be markers provided by the user and/or markers provided by other users (e.g., friends, a community, or any entity (such as a stranger)).

Interface component 218 can provide a graphical user interface (GUI), a command line interface, a speech interface, Natural Language text interface, and the like. For example, a GUI can be rendered that provides a user with a region or means to load, import, select, read, and so forth, various requests and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate information conveyance such as vertical and/or horizontal scroll bars for navigation and toolbar buttons to determine whether a region will be viewable can be employed. Thus, it can be inferred that the user did want the action performed although the user did not complete the action.

The user can also interact with the regions to select and provide information through various devices such as a mouse, a roller ball, a keypad, a keyboard, a pen, gestures captured with a camera or motion sensors (e.g., accelerometers), and/or voice activation, for example. Typically, a mechanism such as a push button or the enter key on the keyboard can be employed subsequent to entering the information in order to initiate information conveyance. However, it is to be appreciated that the disclosed aspects are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

Interface component 218 can receive markers from merge component 214. In accordance with some aspects, merge component 212 combines, deletes, or performs other processing on the markers 208, 210, 212 at substantially the same time as a request 216 is received. However, in accordance with some aspects, merge component 214 performs processing on the markers 208, 210, 212 at about the same time as a marker 204 is received. For example, upon receipt of a marker 204, merge component 214 can automatically determine whether the newly received marker 204 should be combined with a previously received marker, is a duplicate of a previous marker, adds more information to a previous marker, and so forth.

In accordance with some aspects, the marker is an advertisement that is automatically presented to a user by interface component 218 when a current user location matches a location associated with the advertisement. For example, when a user is physically near a store (or is virtually navigating around the store in a mapping application), an advertisement for that store can be automatically presented to the user.

Alternatively or additionally, system 200 can include or be operatively connected to a data store 220. Data store 220 is intended to be a repository of all or portions of markers, combinations of markers, marker sets, merged markers, or information described herein or otherwise suitable for use with the disclosed aspects. Data store 220 can be centralized, either remotely or locally cached, or distributed, potentially across multiple devices and/or schemas. Furthermore, data store 220 can be embodied as substantially any type of memory, including but not limited to volatile or non-volatile, sequential access, structured access, or random access and so on. It should be understood that all or portions of data store 220 can be included in system 200, or can reside in part or entirely remotely from system 200. Further, although illustrated as accessible by merge component 214, data store 220 can be accessible by any system component.

By way of example and not limitation, interface component 218 receives a request 216 related to a geographic location. Interface component 218 communicates the request to merge component 214, which selectively accesses one or more markers retained in data store 220. Merge component 214 receives from data store 220 one or more markers associated with the geographic location and can perform processing on the markers (e.g., identify duplicates, and so forth) and convey the markers to interface component 218. The markers are output 222 to the requesting entity in any perceivable format (e.g., visual, audio, tactile, and so forth).

The output 222 can also include information associated with the rendered markers. For example, the information can include whether the marker a real-world marker, a virtual marker, or a different type of marker. Other information can include an identification of the entity that provided the marker (taking into account privacy concerns), links to other information related to the marker, and/or geographic location or other information. In accordance with some aspects, the marker can be rendered with information related to when (day and time) the marker was provided, which can provide the requestor the opportunity to determine whether the marker is still valid (e.g., has something changed related to the location since the marker was provided).

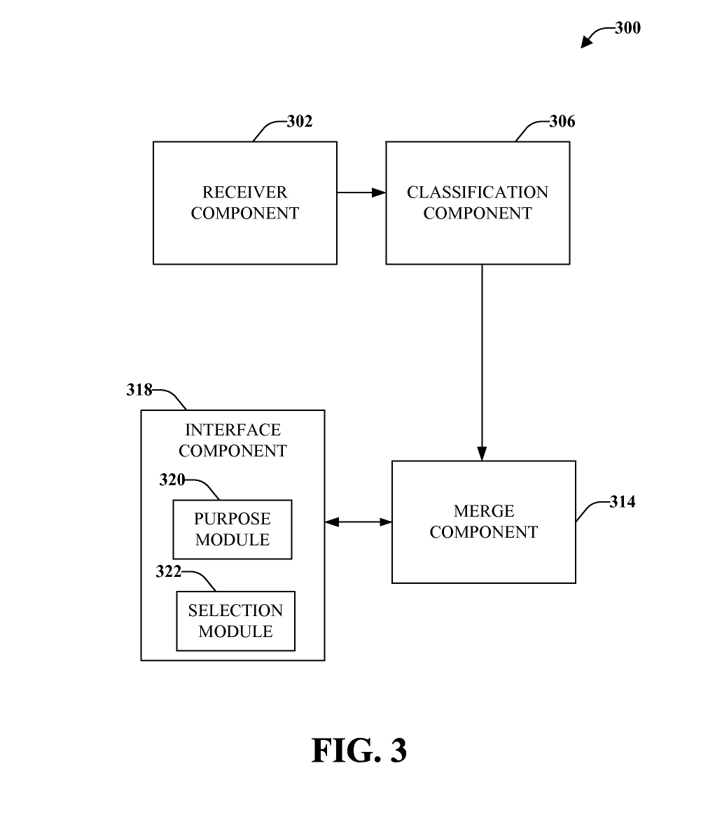

With reference now to FIG. 3, illustrated is a system 300 for selecting one or more markers for output to a user in accordance with an aspect. Included in system 300 is a receiver component 302 that accepts markers from different entities. The markers can be related to various geographic locations. A classification component 306 indexes the received markers as a function of the geographic location that the marker relates to as well as the value of the marker. The value can indicate that the marker is a virtual marker and, thus, there might be a question as to the accuracy and/or reliability of the marker. In another aspect, the value can indicate that the marker is a real-world marker and, thus, the entity providing the marker was physically located at (or near) the geographic location related to the marker. A merge component 314 can combine or perform other functionality with markers that are related (e.g., correspond to a similar geographic area).

An interface component 318 receives a request for one or more markers associated with a geographic location. The request can be an explicit request or an implicit request. The explicit request can be received when the requestor manually provides information such as by entering the request though a keyboard or other interface, verbally requests the markers, and so forth. The request can be a general request for information about a location (e.g., “What have others said about this place?”). An implicit request (or inferred request) can be received when a user is traveling virtually in a mapping application while that user is physically located at their office, for example. As the user zooms to various viewing level degrees (e.g., zooms in, zooms out, and so on), the user might zoom to a viewing level that focuses on a particular place (e.g., a house for sale). Based on the zoom level (or viewing degree), information about that location might automatically be presented to the user.

In accordance with some aspects, a marker might be automatically presented when a user is near a location. For example, an advertiser can purchase advertisement space (such as though a bidding process) for a particular geographic area. When a person is physically located in that particular geographic area, the person can automatically perceive the advertisement (e.g., on a user device). In accordance with some aspects, as a user is virtually visiting the geographic location, the user might be presented with a similar advertisement, which can be an advertisement directing the user to the advertiser's website in order for the user to make a purchase, for example.

When viewing markers on-line, it is possible to purchase different sizes of regions for different advertisements. For example, a rendered advertisement can refer to an advertiser on a country level, while a competitor's advertisement is shown at a city level or to a local store when the user is zooming to street level. In the real world, the radius of interest of a user can be determined by location (e.g., near central station, show city level advertisements, further, while in a specific neighborhood, local advertisement can be more important), or by a mode of transportation (e.g., a user driving a vehicle might not pay attention to very localized markers).

In accordance with some aspects, markers can be generated by localized news articles. In this case, a user may be exposed to different news items that are relevant to an area where the user is location and/or is viewing on-line. These news articles can also include a temporal aspect, wherein after a certain interval that marker is no longer rendered and can be replaced by a different marker (e.g., news article).

Included in interface component 318 is a purpose module 320 that is configured to determine a reason for the request, which can be utilized to ascertain which, if any, markers should be provided to the requestor. In the case of markers that are automatically rendered when predefined criteria is met (e.g., the user is physically or virtually at a particular geographic location), the marker can be automatically output without determining the reason for the request. In the case of explicit requests, parameters associated with the user can be evaluated to tailor the markers for the requestor. For example, parameters can relate to historical information (e.g., markers for which the requestor has expressed interest in the past), user preferences (e.g., only provide real-world markers, and other considerations.

As a function of at least the reason of the request, a selection module 322 chooses at least one marker from the merged markers (or an individual marker if there are no markers to merge (e.g., if only one marker is available for a location). The merged markers (or unmerged markers) can be maintained in a computer-readable storage medium. The markers are chosen by selection module 322 as a function of the reason for the request and/or based on evaluated parameters. The selected markers are output though interface component 318 and/or another system component. In accordance with some aspects, associated information can be output at substantially the same time as the marker is output or at a different time. The associated information can relate to the identification of the entity that provided the marker, whether the marker is a real-world marker, a virtual marker, another marker, and/or other information (e.g., time stamp associated with each marker that is output, number of similar markers, and so on).

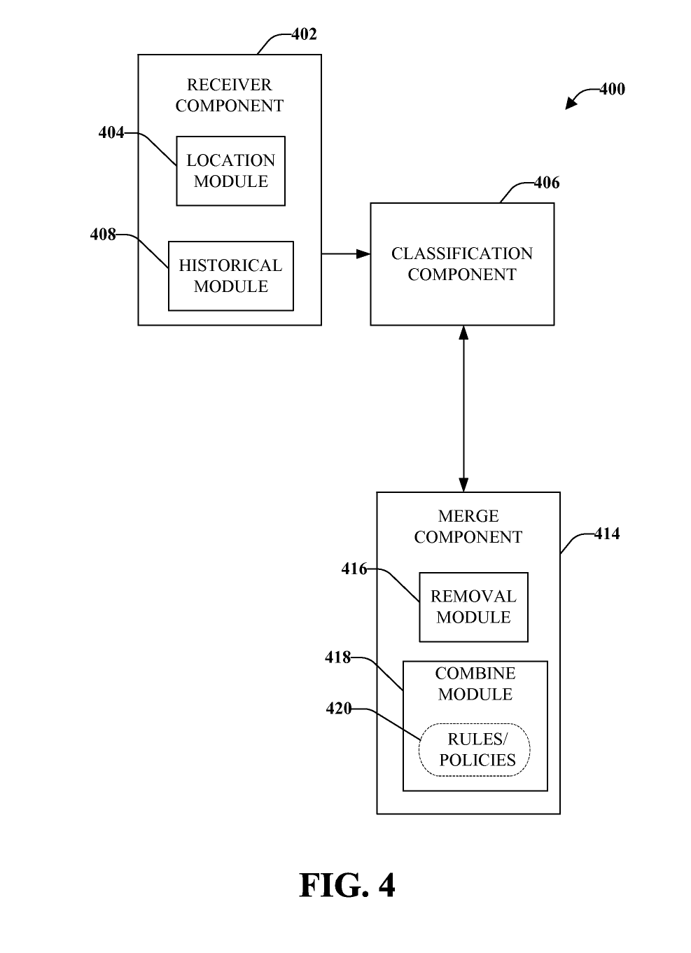

FIG. 4 illustrates a system 400 for selectively merging two or more markers, according to an aspect. System 400 includes a receiver component 402 that accepts a marker from a multitude of entities. A location module 404 is configured to determine a location of entities that provided each marker (e.g., what is the entity location) and a location associated with the marker (e.g., which location does the marker relate to). For example, a person can be located in their house (e.g., in Phoenix, Ariz.) and virtually navigating though space over the Internet. The user might have previously visited France and, thus, would like to enter information about their trip. While sitting in their house in Arizona, the person enters markers describing places to visit and things to do and other facts that she found interesting about France. In this example, the user is located in Phoenix and the marker relates to a location in France (e.g., a virtual marker, a quasi-virtual marker, a quasi-real-world marker, and so on).

Also included in system 400 is a classification component 406 that is configured to index the received markers in different categories. A simple set of categories is to classify each marker as a virtual marker or a real-world marker. However, in accordance with some aspects, there can be classifications of markers that are different from real-world markers and virtual markers. According to some aspects, markers can be categorized as “potential locations.” For example, while in a restaurant, a location reading apparatus might indicate a position outside the restaurant. In this case, the user that is providing the marker can be given the opportunity to correct the slightly inaccurate location.

Further, markers can be classified as “child markers”, wherein there is an anchor point or anchor location in the world (e.g., the restaurant), and the created marker has a subordinate relationship to that anchor location. Thus, the child marker obtains its position or other “inherited” properties from the “parent” marker. The advantage of child markers is that if two (or more) people create markers in the same restaurant, the result can be a small graph or tree (hierarchy) of markers. This graph, tree, hierarchy, and so forth, can indicate more semantically then simply sensing that the markers are near each other. These child markers can be effectively the same place since they have the same parent or anchor location. In a similar manner, both virtual and real-world markers can be tied to the same anchor points.

In another example, there can be quasi-real-world markers and/or quasi-virtual markers, which can relate to situations where the marker location does not match the user location, however the user had previously been at the marker location. The determination of whether the user had previously been at the marker location can be made automatically by accessing information provided by a historical module 408 associated with the entity that provided the marker. Historical module 408 can automatically provide relevant information related to the prior activities of the user. This information can be provided at about the same time as the marker is conveyed or at a different time. In accordance with some aspects, historical module 408 can be prompted for information from receiver component 402 and/or classification component 406. Continuing the above example, classification component 406 might determine that the marker is a virtual marker, however a prompt can be sent to historical component 408 to determine if that user had recently been in France (e.g., within a certain time range, such as three months, six months, and so forth). If so, that marker might be determined to be a quasi-virtual marker or another designation.

A merge component 414 is configured to compare the received markers of the same category and/or different categories. For example, merge component 414 can compare a real-world marker with a virtual marker, wherein both the real-world marker and the virtual marker are associated with a similar geographic location. In accordance with some aspects, two or more real-world markers can be compared, two virtual markers can be compared, or combinations thereof (e.g., two or more real-world markers compared with at least one virtual marker, two or more virtual markers compared with at least one real-world marker, and so forth). In accordance with some aspects, two or more other markers can be compared with one (or more) real-world marker and/or virtual markers. The markers can be compared for various criteria such as similar information related to a similar location. In accordance with some aspects the criteria can relate to a time stamp (e.g., date, time) associated with each marker (e.g., rank markers based on newness).

A removal module 416 and a combine module 418 can be associated with merge component 414. Removal module 416 can be configured to purge or delete duplicate markers, erroneous markers (e.g., markers that do not meet at least a threshold level of reliability) and/or markers that should not be rendered to other users (e.g., questionable markers, markers that raise privacy concerns, markers that contain inappropriate content, and so forth). For example, a threshold level of reliability can be based on scores or rankings assigned to a particular marker from users that have reviewed the marker. Each user reviewing the marker can be provided the opportunity to report the marker for various content and/or to evaluate the truthfulness (e.g., reliability) of a marker. If a marker has not received a threshold number of positive votes, that marker can be flagged as a potential marker for deletion. In accordance with some aspects, if a marker has not met the threshold level because it has not been reviewed by enough people, that marker might be rendered with an indication that the trustworthiness of the marker has not yet been confirmed. Further, the user now perceiving the marker can be provided the opportunity to rank or vote on the accuracy of the rendered marker.

Combine module 418 can be configured to evaluate the content of each related marker and make a determination whether the markers contain substantially the same information or different information. If the markers contain substantially the same information, one or more of the duplicate markers can be removed and/or joined and/or embedded with another marker. Various criteria can be established to make a determination whether to remove (or embed) duplicate markers. For example, if it is ascertained that two markers contain similar information based on an evaluation of words, phrases, strings, and so forth (e.g., a first marker indicates, “It is best to visit this landmark on Tuesdays because it is less crowed” and a second marker indicates “there are not many visitors on Tuesdays”), a decision can be made to remove one of the markers or to embed the first marker in the second marker. This criteria can be established based on policies and/or rules 420. For example, a policy can be established that if two (or more markers) contain substantially the same information, the more recent (in time) marker is retained and the less recent (or older) marker is discarded. In another example, a policy can be that a real-world marker is retained while a virtual marker is ignored (or discarded) if both markers contain substantially the same information. The rules and/or polices can be configurable such that any criteria can be established.

The functionality of merge component 414, removal module 416, and/or combine module 418 can occur at about the same time as a marker is accepted by receiver component 402. In accordance with some aspects, merge component 414, removal module 416, and/or combine module 418 perform respective processing at about the same time as a request for markers related to a geographic location is received in a mapping application.

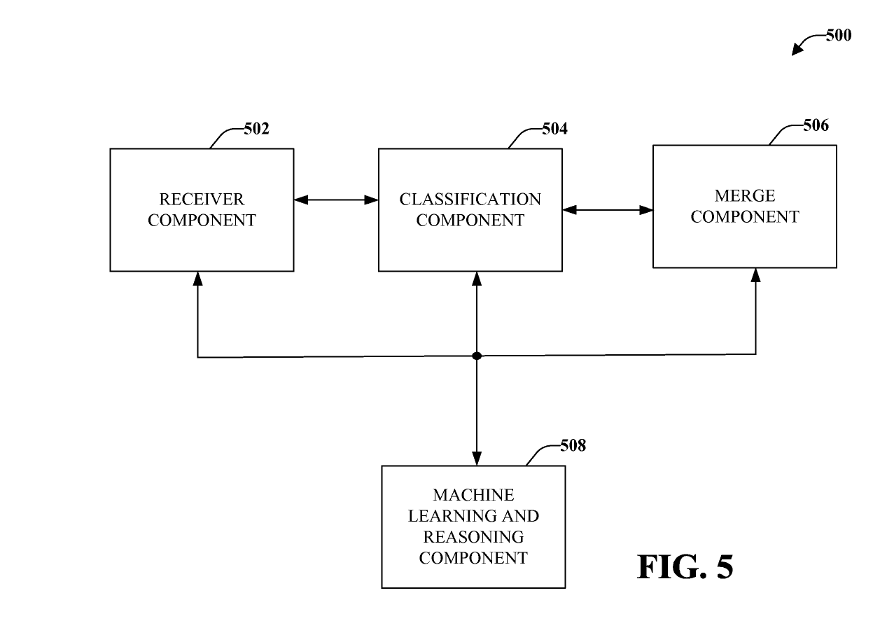

FIG. 5 illustrates a system 500 that employs machine learning and reasoning to automate one or more features in accordance with the disclosed aspects. Included in system 500 is a receiver component 502 that receives markers from different users, the markers are associated with a geographic location. The different users can be in various geographic locations. For example, a first user can be in a geographic location that is not the geographic location that corresponds to the marker the user is inputting. For example, the marker might be about a location that the user visited last week, the marker is a request for information about a location the user is interested in and/or would like to visit, and so on. In accordance with some aspects, the user can be physically present in (or relatively near) the geographic location that corresponds to the marker (e.g., the user is visiting a location and would like to record personal information, such as a reminder to do something the next time the user visits that area (e.g., a reminder note).

Also included in system is a classification module 504 that distinguishes among different marker categories. For example, real-world markers relate to markers whose geographic location corresponds with a geographic location of a user at a similar time as the marker was input. Virtual markers relate to markers for a geographic location but the user is physically present in a different geographic location. Other categories can relate to potential locations, child markers, parent markers, quasi-virtual markers, quasi-real-world markers, and so on. A merge component 506 can be configured to selectively merge the different markers and/or categories of markers, which correspond to a similar location.

A machine learning and reasoning component 508 can employ various machine learning techniques to automatic one or more features associated with system 500. The machine learning and reasoning component 508 can employ principles of probabilistic and decision theoretic inference and rely on predictive models constructed through the use of machine learning procedures. Logic-centric inference can also be employed separately or in conjunction with probabilistic methods. The machine learning and reasoning component 508 can infer marker classifications by obtaining knowledge about the entity that provided the marker, the content of the marker, the similarities or difference between markers, location information, or combinations thereof. Based on this knowledge, the machine learning and reasoning component 508 can have a marker tagged with information related to the category of marker (e.g., real-world marker, virtual marker, quasi-real-world marker, quasi-virtual marker, informational marker, inquiry marker, parent marker, child marker, potential marker, and so on).

In accordance with some aspects, machine learning and reasoning component 508 can delete markers, merge markers, disregard markers, or perform other actions with respect to markers. For example, if two markers are received that contain similar information related to a place (e.g., “this restaurant is open until 2 a.m. every morning”), machine learning and reasoning component 508 can determine that only one marker that contains this information should be retained. In another example, if a received marker contains erroneous data, offensive data, and so on, machine learning and reasoning component 508 can delete the marker or flag the marker for potential deletion or removal from a database of markers, which can, alternatively or additionally, be performed manually.

Alternatively or additionally, machine learning and reasoning component 508 can determine, based on a request for markers, whether merged markers should be output or whether a subset of the merged markers should be output. The determination can be made based on criteria associated with the entity that requested markers associated with a certain geographic area. For example, a determination can be made whether the requestor is interested in receiving all markers in order for the requestor to make his own determination as to the usefulness of the markers. In another example, the requestor might be interested in receiving a marker associated with questions related to the location so that the requestor can answer the questions and/or prompt himself for further information about the location, based on questions he would not have thought to ask.

If machine learning and reasoning component 508 has uncertainty related to type of marker, the entity that provided the marker, the entity that requested the marker, and so on, machine learning and reasoning component 508 can automatically engage in a short (or long) dialogue or interaction with the various entities (e.g., “Where are you located?” “Have you ever physically been at that location?” “What types of markers are you interested in receiving”). In accordance with some aspects, machine learning component 508 engages in the dialogue with the entities through another system component. Computations of the value of information can be employed to drive the asking of questions.

According to some aspects, machine learning and reasoning component 508 can make an inference based on the probability that a particular entity is interested in a particular type of marker (e.g., this user has historically meant a request to be for a certain type/content of marker). If there is uncertainty, a prompt can be sent to the entity for confirmation. There can be an inference based on an entity, based on a group, or based on commonality among a group of entities.

The various aspects (e.g., in connection with receiving markers, determining the classification of markers, distinguishing a marker request for a specific type of marker from a request for all markers associated with a location, and so forth) can employ various artificial intelligence-based schemes for carrying out various aspects thereof. For example, a process for determining if a particular marker is a real-world marker, a virtual marker, or a different type of marker can be enabled through an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer a marker type and/or what markers should be rendered. In the case of markers, for example, attributes can be common markers, a combination of markers, a pattern of markers, and the classes are criteria associated with a provider of the marker and/or a requestor of the marker.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more aspects can employ classifiers that are explicitly trained (e.g., through a generic training data) as well as implicitly trained (e.g., by observing user behavior, receiving extrinsic information). For example, SVM's are configured through a learning or training phase within a classifier constructor and feature selection module. Thus, the classifier(s) can be used to automatically learn and perform a number of functions, including but not limited to determining according to a predetermined criteria how to categorize a marker, which marker or markers (if any) to render upon request, which markers to group together, relationships between markers, and so forth. The criteria can include, but is not limited to, similar markers, historical information of the marker, the provider, the requestor, and so forth.

Additionally or alternatively, an implementation scheme (e.g., rule) can be applied to control and/or regulate markers, inclusion of a group of markers, privileges, and so forth. It will be appreciated that the rules-based implementation can automatically and/or dynamically evaluate a marker based upon a predefined criterion. In response thereto, the rule-based implementation can automatically interpret and carry out functions associated with the marker (e.g., ignoring, merging, deleting, rendering) by employing a predefined and/or programmed rule(s) based upon any desired criteria.

In view of the exemplary systems shown and described above, methodologies that may be implemented in accordance with the disclosed subject matter, will be better appreciated with reference to the following flow charts. While, for purposes of simplicity of explanation, the methodologies are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

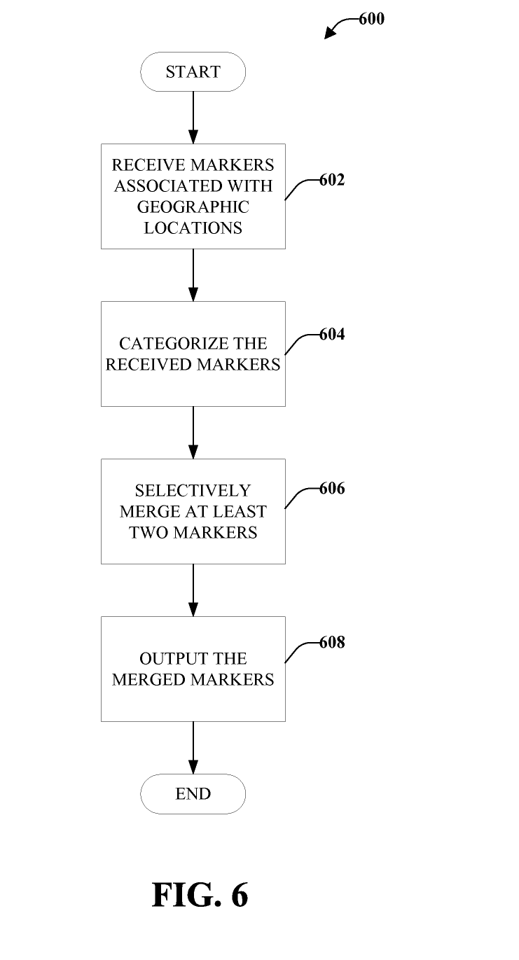

FIG. 6 illustrates a method 600 for rendering markers in a mapping application, according to an aspect. Method 600 starts, at 602, when at least one marker associated with a geographic location is received. The geographic location can be a specific place (e.g., building, address, and so forth) or a general location (e.g., road, street, city, area, volume, and so on). The geographic location can be identified based on a manual entry of an address, a name of the location (e.g., name of landmark, building name, intersection name), geographic coordinates, and so forth. In accordance with some aspects, the geographic location can be identified automatically based on a location of an entity that provided the marker, such as through GPS and/or other locating techniques. In some aspects, the location of the marker can be chosen and/or changed by the provider of the marker (e.g., based on potential locations). In another aspect, markers can be child markers that are associated with a parent marker, which can be an anchor point for the child markers. The child markers can be linked to the parent markers though a manual entry and/or automatically based on previous linked entries, other historical data, and/or through an inference.

At 604, the received markers are tagged with a category in which the marker belongs. For example, categories can include virtual markers and real-world markers, or any type there between (e.g., quasi-virtual marker, quasi-real-world marker, and so forth). In accordance with some aspects, the categories can include information markers (e.g., general information related to the location), inquiry markers (e.g., a question about the location is requested), and so on. Other marker categories include child markers, parent markers, and/or potential location markers.

One or more markers are selectively merged, at 606, creating a hybrid of markers, which can be the same category or different categories. The merging can be a function of removing duplicate markers or markers that convey substantially the same information as another marker. The merging can be based on evaluating the content of geographically related markers.

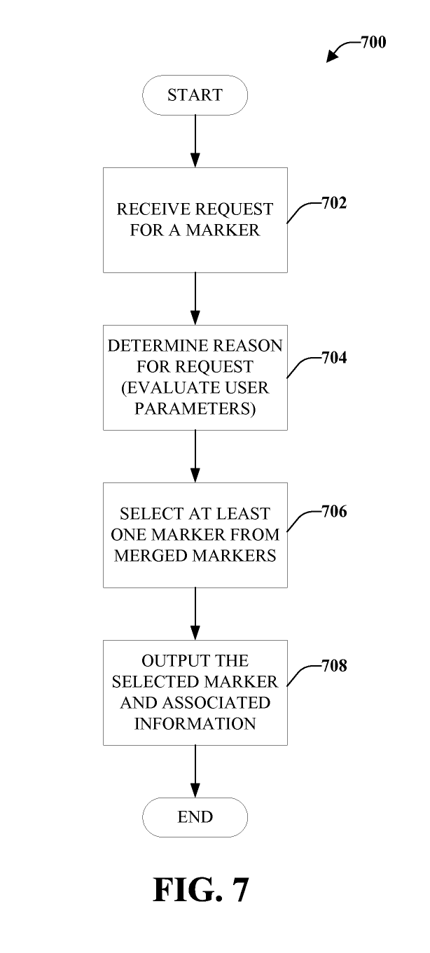

At 608, at least a subset of the merged markers are rendered based upon a request. The request can be received from a user that is physically at the location and/or a user that is virtually visiting the place through interaction with a mapping application. In accordance with some aspects, when it is detected that the user is either physically or virtually at the location, markers can be automatically rendered (e.g., advertisement, emergency alert, and so on). Determining whether to render all the merged markers or only a subset of markers can be made based on various criteria including preferences of the requestor, historical information associated with the requestor, a reason for the request, and/or based on other factors. Further information related to determining which, if any, markers to render is now be discussed with reference to FIG. 7, which illustrates a method 700 for selecting one or more markers for output to a user in accordance with the disclosed aspects.

At 702, a request for a marker is received. The request can be an explicit request received when the requestor manually provides information such as by entering the request though a keyboard or other interface, verbally requesting the markers, and so forth. The request can be a general request for information about a location (e.g., “What have other said about this place?”). In accordance with some aspects, the request can be an implicit request or an inferred request. For example, a user might be traveling virtually in a mapping application while that user is physically located at their office. As the user zooms to various viewing level degrees (e.g., zooms in, zooms out, and so on), if the user views to a viewing level that focuses on a particular place (e.g., a house for sale), information about that location might automatically be presented to the user based on the viewing degree (e.g., show if focused on a single house, do not show if focused on entire street or city).

In accordance with some aspects, a marker might be automatically presented when a user is near a location. For example, an advertiser can purchase advertisement space (such as though a bidding process) for a particular geographic area. As users are physically located in that particular geographic area, the user can automatically perceive the advertisement. In accordance with some aspects, as a user is virtually visiting the geographic location, the user might be presented with a similar advertisement, which can be an advertisement directing the user to the advertiser's website in order for the user to make a purchase and/or to obtain other information. Other markers might relate to news events and/or emergency events.

A reason for the request is determined, at 704, to evaluate which, if any, markers should be provided to the requestor. In the case of markers that are automatically rendered when predefined criteria is met (e.g., the user is physically or virtually at a particular geographic location), the marker can be automatically output without determining the reason for the request. In the case of explicit requests, parameters associated with the user can be evaluated. For example, parameters can relate to historical information (e.g., markers for which the requestor has expressed interest in the past), user parameters, and so forth.

At 706, at least one marker from the merged markers is selected. However, it should be understood that if only one marker is available for a geographic location, then that marker can be rendered. The merged markers (or unmerged markers) can be maintained in a computer-readable storage medium. The marker is selected as a function of the reason for the request and/or based on evaluated user parameters. The selected marker is output, at 708, in any perceivable format as determined by the type of marker to be presented, user preferences, and/or device capabilities. In accordance with some aspects, associated information can be output at substantially the same time as the marker is output or at a different time. The associated information can relate to the identification of the entity that provided the marker, the category of the marker, or other information (e.g., time stamp associated with each marker that is output, number of similar markers, and so on).

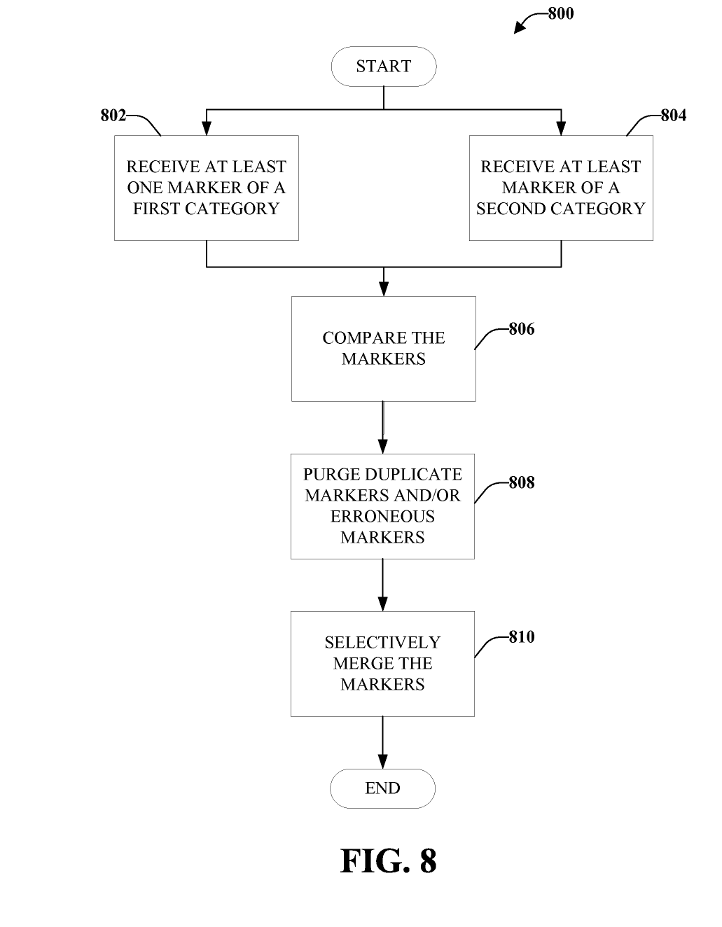

FIG. 8 illustrates a method 800 for selectively merging two or more markers, according to an aspect. Method 800 starts, at 802, when a first marker is received. The first marker can be associated with a first category or type of marker. Additionally or alternatively, method 800 can start, at 804, when at least a second marker is received. The second marker can relate to a second category. However, in accordance with some aspects, the second (or subsequent markers) can be the same category as previously received markers. The markers can be received from different entities and/or from the same entity. For example, a person can supply a real-world marker about a place where the person is physically located. Further, the same user can enter information associated with a different location, where the user is not located when providing the marker. Further, the markers can be received at different times.

At 806, the markers are compared, wherein the markers are associated with a similar geographic location. In accordance with some aspects, two or more real-world markers can be compared, two virtual markers can be compared, or combinations thereof (e.g., two or more real-world markers compared with at least one virtual marker, two or more virtual markers compared with at least one real-world marker, and so forth). Further, any combinations or categories of markers can be compared, according to the various aspects presented herein. The markers can be compared for various criteria such as similar information related to a similar location. In accordance with some aspects the criteria can relate to a time stamp (e.g., date, time) associated with each marker (e.g., rank markers based on temporal considerations).

At 808, duplicate markers and/or erroneous markers are purged or removed automatically and/or manually. In such a manner, the duplicate and/or erroneous markers are not output to a user. In accordance with some aspects, various criteria are established to determine whether to remove duplicate markers. For example, if two markers contain similar information (e.g., a first marker indicates, “It is best to visit this landmark on Tuesdays because it is less crowed” and a second marker indicates “there are not many visitors on Tuesdays”), a decision can be made to remove one of the markers. This criteria can be established based on policies and/or rules. For example, a policy can be established that if two (or more markers) contain substantially the same information, then a more recent (in time) marker is retained and the less recent (or older) marker is discarded. In another example, a policy can be that a real-world marker is retained while a virtual marker is ignored (or discarded) if both markers contain substantially the same information. In a further example, a policy or rule can be established such that a parent marker is retained while a child marker that contains duplicate information is discarded.

At 810, one or more markers are selectively merged. In accordance with some aspects, the markers can be merged prior to retaining the markers in a storage medium. However, in accordance with some aspects, the markers are not merged until there is a request for markers associated with a geographic location. The aspects that retain the markers in a merged format can respond to a request faster than those that merge the markers at substantially the same time as receiving the request.

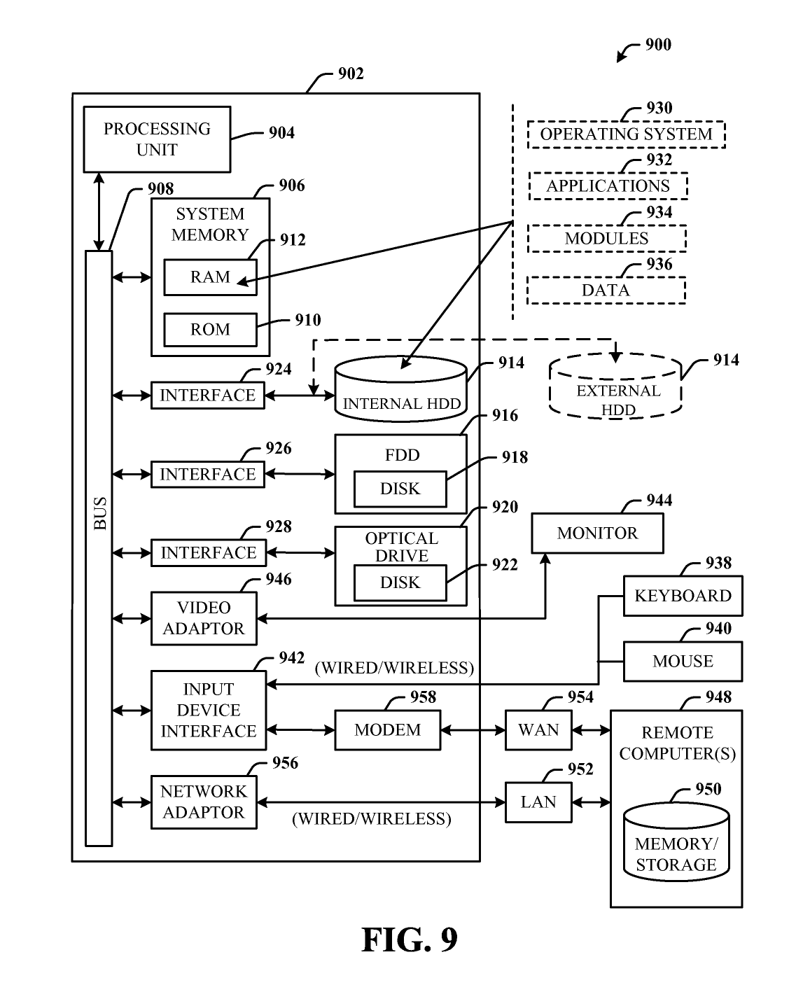

Referring now to FIG. 9, there is illustrated a block diagram of a computer operable to execute the disclosed architecture. In order to provide additional context for various aspects disclosed herein, FIG. 9 and the following discussion are intended to provide a brief, general description of a suitable computing environment 900 in which the various aspects can be implemented. While the one or more aspects have been described above in the general context of computer-executable instructions that may run on one or more computers, those skilled in the art will recognize that the various aspects also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer readable media. Computer readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the one or more aspects.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the various aspects can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 through an interface, such as a video adapter 946. In addition to the monitor 944, a computer typically includes other peripheral output devices (not shown), such as speakers, printers, etc.

The computer 902 may operate in a networked environment using logical connections through wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 through the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

Memory 906, operatively connected to processor 904, can have stored therein computer-executable instructions configured to implement a system that facilitates merging of markers in a mapping application. The system includes an input component that receives a plurality of markers associated with a location in a mapping application. Also included is a classification component that indexes each of the plurality of markers into categories as a function of a user location and the location of the marker in the mapping application. According to some aspects, the marker category is a child marker that points to a parent marker. The marker category can be a real-world marker if the user location and the location of the marker match or a virtual marker if the user location and the location of the marker are different. According to some aspects, the marker is a potential location marker, wherein a correction to the marker location is received by the input component. In accordance with some aspects, the marker is an advertisement that is automatically presented by an interface component when a current user location matches a location associated with the advertisement. The classification component can tag the marker with the classification.

Alternatively or additionally, the system can include a merge component that selectively merges at least two markers of a same or a different category for rendering both markers in a mapping application. In accordance with some aspects, system can include an interface component that accepts a request for markers associated with a geographic area in the mapping application and an output component that renders the merged markers associated with the geographic area. According to some aspects, system includes a removal component that deletes at least one marker as a function of detected duplication, an erroneous marker, or marker content. Alternatively or additionally, system can include a combine module that evaluates content of each marker and joins the markers if the content matches.

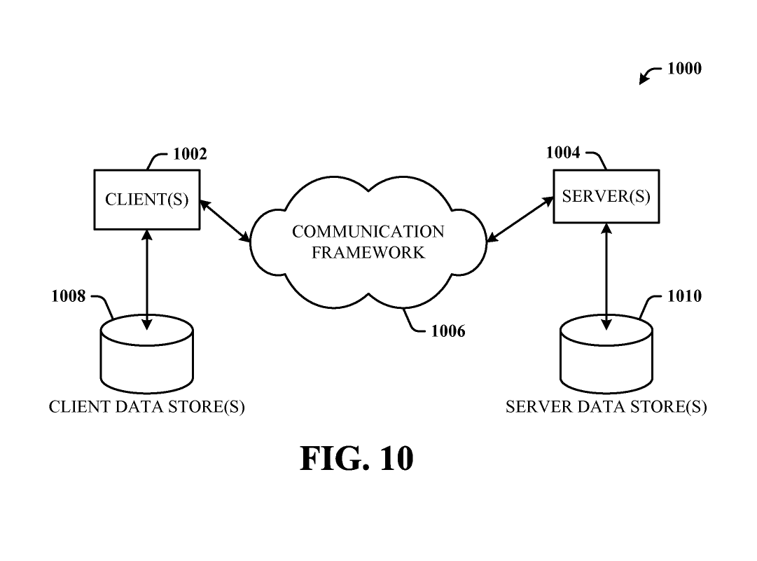

Referring now to FIG. 10, there is illustrated a schematic block diagram of an exemplary computing environment 1000 in accordance with the various aspects. The system 1000 includes one or more client(s) 1002. The client(s) 1002 can be hardware and/or software (e.g., threads, processes, computing devices). The client(s) 1002 can house cookie(s) and/or associated contextual information by employing the various aspects, for example.

The system 1000 also includes one or more server(s) 1004. The server(s) 1004 can also be hardware and/or software (e.g., threads, processes, computing devices). The servers 1004 can house threads to perform transformations by employing the various aspects, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated through a wired (including optical fiber) and/or wireless technology (including non-radio wireless communications). The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification intended to embrace all such alterations, modifications, and variations.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.”

The term “or” as used in either the detailed description or the claims is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the one or more aspects may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

What is claimed is:

1. A system that facilitates merging of markers in a mapping application, comprising:
an input component that receives a plurality of markers associated with a location in a mapping application;
a classification component that indexes each of the plurality of markers into categories as a function of a user location and the location of the marker in the mapping application; and
a merge component that selectively merges at least two markers of a same or a different category for rendering both markers in a mapping application.

2. The system of claim 1, further comprising:
an interface component that accepts a request for markers associated with a geographic area in the mapping application; and
an output component that renders the merged markers associated with the geographic area.

3. The system of claim 1, the marker category is a child marker that points to a parent marker.

4. The system of claim 1, the marker category is a real-world marker if the user location and the location of the marker match or a virtual marker if the user location and the location of the marker are different.

5. The system of claim 1, the marker is a potential location marker, wherein a correction to the marker location is received by the input component.

6. The system of claim 1, the classification component tags the marker with the classification.

7. The system of claim 1, further comprising a removal component that deletes at least one marker as a function of detected duplication, an erroneous marker, or marker content.

8. The system of claim 1, further comprising a combine module that evaluates content of each marker and joins the markers if the content matches.

9. The system of claim 1, the marker is an advertisement that is automatically presented by an interface component when a current user location matches a location associated with the advertisement.

10. A method performed by a user device for selectively merging markers in a mapping application, comprising:
receiving at least two markers that relate to geographic locations;
comparing the markers for content and the geographic locations;
selectively merging the markers if the geographic location of the markers match; and
rending the merged markers on the user device in response to a request for the geographic location in a mapping application.

11. The method of claim 10, comparing the markers for content comprises determining similarities of the content and removing at least one of the markers based on the similarities.

12. The method of claim 10, the request is automatically received when a user location matches the geographic location.

13. The method of claim 12, the user location is a physical location or a virtual location.

14. The method of claim 10, further comprises removing duplicate markers as a function of the content, the removal is deletion of at least one marker or embedding of the markers.

15. The method of claim 10, the marker is an advertisement that is automatically rendered when a user location matches the geographic location associated with the advertisement.

16. The method of claim 10, further comprise categorizing each marker as a real-world marker, a virtual marker, a parent marker, a child marker, a potential location maker, an information marker, an inquiry marker, a quasi-real-world marker, or a quasi-virtual marker.

17. The method of claim 16, the marker is a real-world marker if the user location and the location of the marker are the same or the marker is a virtual marker if the user location and the location of the marker are different.

18. A computer-readable medium having stored thereon the following computer executable components:
a receiver component that accepts a plurality of markers, the markers include location information that correspond to geographic coordinates;
a classification component that evaluates each of the plurality of markers and indexes each marker as a real-world marker, a virtual marker, a quasi-real-world marker, a quasi-virtual marker, a potential location marker, a parent marker, or a child marker;
a merge component that reviews the location information of each marker and associates markers based on the location information;
a combine module that combines associated markers as a function of content; and
an interface component that selects at least one marker for presentation, the index of each marker and associated markers are presented with the selected marker.

19. The computer-readable medium of claim 18, further comprising a removal component that deletes at least one marker as a function of a detected duplication, an erroneous marker, or marker content.

20. The computer-readable medium of claim 18, the marker is an advertisement that is automatically presented when a user location matches the location information of the advertisement.
